(19) United States
(12) Patent Application Publication
(10) Pub. No.: US 2012/0116994 A1
(43) Pub. Date: May 10, 2012

(54) Dynamic Portfolio Monitoring

(75) Inventors: Richard O. Michaud, Boston, MA (US); Robert Michaud, Boston, MA (US); David N. Esch, Boston, MA (US)

(73) Assignee: MICHAUD PARTNERS LLP, Boston, MA (US)

(21) Appl. No.: 13/234,575

(22) Filed: Sep. 16, 2011

Related U.S. Application Data
(60) Provisional application No. 61/383,948, filed on Sep. 17, 2010.

(51) Int. Cl. G06Q 40/06

(52) U.S. Cl. 705/36 R

(57) ABSTRACT

Michaud rebalance probabilities are renormalized in the case of successive datasets, historical or simulated, where partial commonality of information is imputed to the two datasets. Two separate sets of optimization inputs correspond to a stochastic process and optimization subject to a set of constraints making the optimization analytically intractable. A subset of data drawn on the basis the first optimization input is recursively replaced with data sampled from the second optimization input, the extent of replacement governed by the extent of common information. A set of rebalance probabilities is calculated, and the L^{th} percentile is selected from the set of rebalance probabilities, where L is a specified confidence level. An adjusted critical value serves as a need-to-execute trigger for a single portfolio or a class of portfolios.

The present application claims priority from U.S. Provisional Patent Application Ser. No. 61/383,948, filed Sep. 17, 2010, and incorporated herein by reference.

### TECHNICAL FIELD

The present invention relates to methods and apparatus for calibrating a threshold that is derived from a statistical process, and, more particularly, embodiments of the present invention may be applied to asset management.

### BACKGROUND ART

Professional asset management requires effective portfolio monitoring. Managers must decide when a current portfolio is sufficiently different from target to recommend trading. However, even sophisticated institutional managers typically use ad hoc rebalancing rules. Many approaches to this problem are in the literature, but few address the obvious suboptimality of ignoring portfolio context or of strictly calendar-mandated trading. Most authors, further, ignore the essential statistical character of the rebalancing decision, which depends on estimating the similarity between the currently held portfolio and an appropriate target portfolio.

Moreover, almost all of the few statistical procedures that have been proposed to date are based on unrealistic assumptions in order to guarantee test statistics with familiar null distributions. Real-world quantitative portfolio management demands inequality constraints on portfolio weights (i.e., the proportion of a portfolio invested in a particular asset class is less or greater than a specified level) and targeted risk levels typically on an efficient frontier in the risk-return plane. To meet these demands, practical decision rules must use computer-intensive methods to create optimality tests that would be intractable using traditional analytical techniques.

The Michaud rebalancing rule was introduced in Chap. 7 of Michaud, Efficient Asset Management, A Practical Guide to Stock Portfolio Optimization and Asset Allocation, (1^{st} ed., 1998) (hereinafter, Michaud, 1998) and refined in Chap. 7 of Michaud et al., Efficient Asset Management, Oxford University Press (2^{nd} ed., 2008) (hereinafter, Michaud, 2008a), both of which are incorporated herein by reference. The Michaud rebalancing rule represents the first practical portfolio optimality test and operates by comparing the tracking error of a current portfolio from a targeted optimal portfolio to the tracking errors of statistically similar optimal portfolios. “Tracking error” refers to a norm expressing a measure of the distance in portfolio space of the current portfolio relative to the targeted optimal portfolio. A high value of the rebalance probability indicates trading to the optimal is desirable. The trading decision depends on the level of confidence associated with the strategy, manager styles, and other issues.

The Michaud rebalancing rule tests a current portfolio for statistical deviation from a targeted portfolio on the Michaud Resampled Efficient Frontier, as described in
Michaud (1998);
Michaud et al. (2008a);
Michaud et al., Estimation Error and Portfolio Optimization: A Resampling Approach, 6 J. Investment Management pp. 8-28 (2008b); and in
U.S. Pat. Nos. 6,003,018, 6,928,418, 7,412,414, and 7,624,060, all of the foregoing publications, collectively “Michaud,” being incorporated herein by reference.

In accordance with the Michaud rebalancing rule, the proximity between a current portfolio P (where P is the vector of weights of the components of the portfolio) and a particular Resampled Efficient Frontier (REF) portfolio P₀ may be measured on the basis of the norm (P−P₀)′*Σ*(P−P₀) , where (P−P₀) is the difference vector of the portfolio weights, (P−P₀)′ represents the transpose of (P−P₀) , and Σ is the return covariance matrix used in the optimization. More generally, any discrepancy function [symbol] (P₁, P₀) having the mathematical properties of a norm may be used to score suboptimal portfolios. Simulated mean variance (MV) efficient frontiers and the associated optimal portfolios are calculated for a given REF portfolio, where “associated” may refer to various association procedures (such as rank-ordered association, for example), as discussed previously in the Michaud references. Once the associated optimal portfolios for each REF portfolio P₀ are calculated, their “distances,” or relative variances, (according to the (P−P₀)′*Σ* (P−P₀) norm) are sorted by magnitude. The percentile value of the sorted relative variances defines a “need-to-trade” probability. Thus, a portfolio with a relative variance greater than, say, the 90^{th} percentile value has a “need-to-trade” probability of 90%.

The Michaud rebalancing rule, as applied in the prior art in a monitoring context, and, in particular, in testing whether a portfolio should be rebalanced, has an important limitation. The decision to trade is generally a function of accumulated new data. In practice, much of the same information that was used to create the existing portfolio is often reused in the new optimization. This partial input match results in a reduction of statistical distance and an overly conservative rebalance signal. That means that newly resampled portfolios appear to “bunch” in the neighborhood of the existing portfolio, making it more likely that trading may not be called for when statistically warranted.

It would be desirable, therefore, for there to be some method for taking overlapping data into account when simulating the outcome of the Michaud rule for statistically optimal portfolios. Such a method is described below, in accordance with the present invention.

One of the most important benefits of professional portfolio management is diligent monitoring and effective trading when necessary. A manager wants to trade as soon as effective but no sooner. However, monitoring rules in practice often ignore statistical considerations even at the most sophisticated institutions. Asset managers often rebalance portfolios on a calendar basis, such as monthly, quarterly, or annually. Alternatively, trades may be recommended whenever some asset weight exceeds a predetermined fixed range, such as plus or minus five percent, from a baseline. Ad hoc rules are rationalized to limit arbitrary rebalancing. Intuitively, trading is recommended if enough time has elapsed or a large enough change has occurred. Some managers routinely trade either monthly, quarterly, or annually. Other popular approaches include trigger points developed from trading cost and volatility considerations (as taught, for example, by Masters 2003). More academic approaches, such as that of Dybvig, Mean-Variance Portfolio Rebalancing with Transaction Costs, working paper, Washington University, available at phildybvig.com (2005), consider the mean-variance optimality of the trade. Another approach is to develop trading rules in a dynamic programming context (as described by Sun et al., Optimal Rebalancing Strategy for Institutional Portfolios, working paper, Massachusetts Institute of Technology (2006)). One solution to the dynamic programming problem was given by Markowitz et al., Single-Period Mean: Variance Analysis in a Changing World, Fin. Analysts J., vol. 59, pp. 30-44 (2003). However, none of the foregoing proposals address the obvious suboptimality of calendar-mandated trading or of ignoring the portfolio context.

The basic limitation of most proposals in the literature is that they ignore the essential statistical character of the monitoring and rebalancing decision. Portfolio monitoring and rebalancing is fundamentally a test of statistical significance. The critical issue is whether the currently held portfolio is statistically similar or different from an appropriate target portfolio. Statistical procedures for portfolio similarity have been given by Shanken in Multivariate Tests of the Zero-Beta CAPM, 14 J. Finan. Econ. pp. 327-57 (1985), which is incorporated herein by reference, as have Jobson et al., Some Tests of Linear Asset pricing with Multivariate Normality, Can. J. Admin. Sciences, vol. 2, pp. 116-40 (1985). Such tests typically assume multivariate normality and are based on the F distribution. Unfortunately, existing procedures are not useful in a practical investment context since they do not allow linear inequality constraints on portfolio weights as well as fail to provide for a targeted portfolio risk on the efficient frontier.

A central difficulty in formulating effective trading rules is that optimality is highly ambiguous. Investment information is typically very uncertain. The problem is particularly evident for quantitative asset managers who use optimizers for defining their portfolios. This is because optimizers are highly unstable. Even insignificant differences in risk-return estimates may result in a very different optimized portfolio.

Ambiguity, instability, and poor out-of-sample performance are well known limitations of mean-variance (MV) optimized portfolios described by Markowitz in Portfolio Selection: Efficient Diversification of Investments (1959). The most serious limitations are due to over sensitivity to estimation error. Michaud (1998) introduced the concept of the Resampled Efficient Frontier™ (REF) or Resampled Efficiency™ (RE) optimization to address the effect of estimation error on portfolio construction. RE optimization uses investment information more realistically, thus leading to more robust, intuitive, stable, and investment effective optimized portfolios. While RE optimization limits the impact of insignificant information and the likelihood of ineffective trades, it is not a monitoring rule. Statistical procedures are required for deciding portfolio optimality and trading advisability.

While procedures for deciding statistical portfolio optimality have been available for some time (such as the procedure described by Shanken (1985)), applicability of at least some of these procedures has been limited because their assumptions did not allow for implementation in practice. In particular, optimality tests limited to analytical techniques did not include linear inequality constrained optimization, which requires computational procedures such as resampling or quadratic programming. Thus, procedures that can handle linear inequality constrained optimization (such as a constraint that a given asset not exceed a specified percentage of the entire portfolio) must be practiced on computing machines and cannot be practiced analytically. In addition an optimality criterion in practice typically is conditioned on the risk level of the monitored portfolio.

In portfolio monitoring applications, another issue needs to be considered in the trading decision: Information used in defining monitored portfolios often includes, in part, information used in the new optimization. For example, suppose a manager computes optimal portfolios based on five years of prior historical monthly return data. A year later the optimal portfolio will have four years of common or overlapping data. The year-old portfolio will be closer to the new optimal portfolio than other portfolios based on completely simulated data, unless the year of new returns is drastically different from the year of returns which dropped off. Rebalancing should be recommended whenever the new returns provide significant evidence of a change in mean-variance that will affect portfolio weights, even when the Michaud rebalance probability is too small to recommend trading at the nominal confidence level. An appropriate statistical optimality test is required, therefore, to account for overlapping data.

### SUMMARY OF EMBODIMENTS OF THE INVENTION

In accordance with embodiments of the invention, methods and apparatus are provided for simulating Michaud rebalance probabilities in the case of successive datasets, historical or simulated, where partial commonality of information is imputed to the two datasets. If an observed statistic is out of line with the simulations, trading should be considered even when the observed rebalance statistic is less than a nominal threshold imposed for the case of entirely independent datasets.

In accordance with one embodiment of the present invention, an apparatus is provided for calibrating a trigger threshold based on two separate sets of optimization inputs corresponding to a stochastic process. The apparatus accounts for common information in the two separate multivariate stochastic inputs. The apparatus has a database server storing an initial portfolio comprising a plurality of assets, each asset characterized by a weighting coefficient, where the weights of the assets define a vector in a portfolio space.

The apparatus also has a processing server on which resides computer-executable software configured to derive need-to-trade probability. The need-to-trade probability is based on a first set of data based, in turn, on a first optimization input and a second set of data based on a second optimization input. The first and the second sets of data are derived by observation, or by resampling or meta-resampling. A computer-executable module resides on the processing server and recursively replaces a subset of the first set of data with data sampled from the second optimization input, thereby generating a substituted set of data, the extent of replacement governed by the extent of common information. A simulated portfolio is generated for each of the substituted sets of data.

Also on the processing server, there is a computer-executable module for calculating a rebalance probability on the basis of the ensemble of simulated portfolios, thereby establishing an adjusted critical value that replaces a specified confidence level L and that is a function of the extent of common information. There is also a computer-executable module for establishing a need-to-trade trigger with respect to the initial portfolio when a rebalance probability exceeds the adjusted critical value corresponding to the specified confidence level L.

In accordance with other embodiments of the present invention, a computer-implemented method is provided for triggering a rebalancing trade on the basis of a two separate sets of optimization inputs corresponding to a stochastic process, the method thereby accounting for common information in the two separate optimization inputs. The method has steps of:
a. drawing a first set of data based on a first optimization input and a second set of data based on a second optimization input, the first and the second sets of data derived by observation, resampling, or meta-resampling;
b. recursively replacing a subset of the first set of data with data sampled from the second optimization input, thereby generating a substituted set of data, the extent of replacement governed by the extent of common information;
c. calculating an ensemble of ersatz optimal portfolios, one ersatz optimal portfolio for each of the substituted sets of data;
d. calculating a rebalance probability on the basis of the ensemble of ersatz optimal portfolios, thereby establishing an adjusted critical value that replaces a specified confidence level L and that is a function of the extent of common information; and
e. triggering a need-to-trade with respect to a current portfolio when an observed rebalance probability exceeds the renormalized critical value corresponding to the specified confidence level L.

In accordance with yet a further embodiment of the invention, the first and second sets of optimization inputs may be based on historical data. A further step of transforming the current portfolio into alignment with a target portfolio may also be performed, when the observed rebalance probability exceeds the adjusted critical value.

### BRIEF DESCRIPTION OF THE DRAWINGS

The foregoing features of the invention will be more readily understood by reference to the following detailed description, taken with reference to the accompanying drawings, in which:

FIG. 1 is a schematic depiction of an RE-optimization process;

FIG. 2 is a flowchart depicting the determination of a need to trade in accordance with one embodiment of the present invention;

FIG. 3 is a flowchart depicting the determination of a need to trade in accordance with one embodiment of the present invention;

FIG. 4 shows simulated rebalance probabilities, replacing k of 120 months for each simulation applied to the data of an asset allocation case for eight capital markets, ad described in Michaud (1998, Chapter 2);

FIG. 5 shows quantile plots of empirically derived Michaud rebalance probabilities for data shown in FIG. 4, in accordance with an embodiment of the present invention; and

FIG. 6 shows one embodiment of a computer that may be used to implement aspects of the invention.

### DETAILED DESCRIPTION OF EMBODIMENTS OF THE INVENTION

The present invention will be more readily understood with reference to Michaud, et al., Portfolio Monitoring in Theory and Practice, J. Investment Management (2012) in press, which is incorporated herein by reference.

Definitions. As used herein, and in any appended claims, the following terms shall have the meanings now described, unless the context requires otherwise:

The term “portfolio” shall refer to the vector of coefficients associated with a set of “assets” or “factors” where the respective weights of the component assets define a point in a space referred to as “portfolio space” and where the range of coefficients are typically subject to equality and inequality constraints. An “asset” may be any state variable of a system. A portfolio shall be represented by the symbol Pₜ, where the index refers to “time,” where a succession of portfolios, or time evolution of a portfolio, is discussed.

An “optimal portfolio” shall refer to a portfolio selected in accordance with specified constraints of any nature so as to maximize expected utility or any other specified criteria subject to constraints such that the maximization is analytically intractable. Quadratic programming with linear inequalities is a common example of an optimization procedure, and a typical optimal portfolio is a portfolio on the resampled efficient frontier computed as the average of properly associated simulated MV efficient portfolios. However any procedure for determining an optimal portfolio is within the scope of the present invention. An optimal portfolio considered in a particular circumstance may be referred to herein as a “target portfolio” for that circumstance.

The term “need-to-trade probability” (or “need-to-execute probability”) shall refer to any quantified measure of the desirability of changing the weights defining an existing portfolio based on a specified criterion and application of statistical methods in accordance with the present invention. The term “need-to-trade probability” and other similar terms employed herein are not limited to a financial context.

The term “rebalance probability” is a cumulative distribution function as defined in paragraph [0045], below. In particular, the term “observed rebalance probability” is defined as the rebalance probability of an actual, or current, portfolio relative to a target portfolio.

A change in the weights defining an existing portfolio shall be referred to herein as a “trade.”

The terms “common information,” and “partial data match,” referring to two datasets (each based on empirical or simulated data), that reflect returns derived from two assumed data distributions (whether based on historical or on simulated data), shall refer to effective information overlap between the two datasets. In the case where the datasets represent successive observations, common information is nothing more than the number of observations in the original data set that remain in the data set that is used to find Pₜ. Effective information overlap may also be imputed based on an anticipated trading period “k” as described below.

Methods and apparatus in accordance with the present invention may be employed advantageously for calibrating a threshold that accounts for common information in prior and current multivariate mean-variance stochastic inputs. The threshold may then be used, in turn, to trigger revision when a related process meaningfully deviates from optimality, or some other specified condition. The process need not be efficient frontier- or resampled-efficient-optimal, although it may be. The process also need not be linear-inequality constrained, although, again, it may be.

In accordance with embodiments of the present invention described below, the distribution of simulated outcomes is used to extend the critical range for the Michaud rule and boost the power of its test. The enhanced decision rule can more effectively monitor a portfolio and indicate trading when desirable. In two exemplary embodiments described below, the second procedure applies to purely historical data, while the first, more general, case refers to managed risk-return estimates. Both embodiments of the invention are illustrated by application to data in several examples. Important applications include a convenient large-scale dynamic framework for automated monitoring of portfolios that may avoid unnecessary trades and enhance investment value.

Generalized Embodiment. Teachings of the present invention are employed in order to take practical and useful actions that are based on information that is known, or estimated, in the aggregate. Thus, for example, a portfolio of investments is built, not on the basis of tomorrow's price of a stock—a quantity that is unknowable today, but, rather, on the basis of how various assets have performed over the course of time, and, possibly, under various circumstances and conditions. Or, in another example, the parameters of a pacemaker may be adapted to a person on the basis of how that person's heartbeat has behaved over the course of time, again, possibly taking into account changes under various circumstances and conditions. Thus, what must be known, and what this invention teaches, is how (and when, or whether) to take definitive action based on results of stochastic, or random, processes. As a starting point, the processes are assumed, either on theoretical or on empirical grounds, or both, to yield results that have particular probabilistic distributions of results.

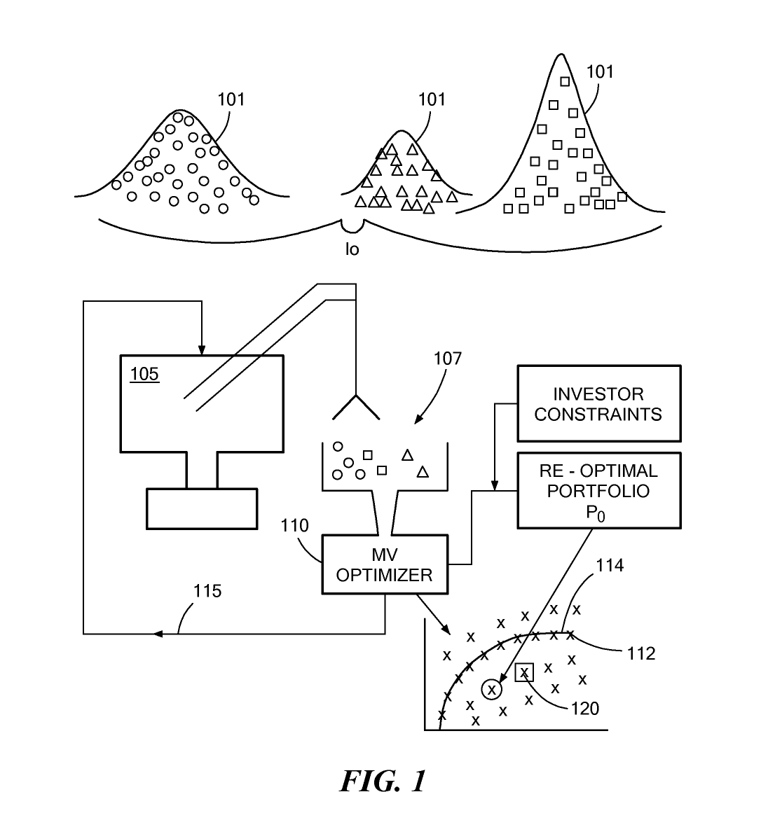

Optimization based on resampling is reviewed with reference to FIG. 1. Optimization input I₀ is a set of defined probability distributions, each distribution characterized by a set of parameters. Thus, for example, an optimization input may be a set of normal (Gaussian) distributions representing the returns of a plurality of classes of investment assets. Each distribution, in turn, is characterized by a mean return μ₀ and a variance Σ₀, so the optimization input I₀ comprises the set of the probability distributions characterizing all of the asset classes, i.e., I₀ ={μ₀, Σ₀}. Of course, the probability distributions may be characterized in other ways, within the scope of the present invention: distributions may be characterized by moments of higher order, such as skewness or kurtosis, and, while normal distributions are preferred for purposes of portfolio analysis, other probability distributions such as a Student's t, or a beta distribution, for example, are subsumed within the scope of the presently claimed invention.

For concreteness, one might consider a probability distribution 101, in FIG. 1, to have been derived, say, from the historical record of returns of a particular investment, say stocks, or bonds. However, the practice of the present invention can accommodate any optimization input I₀, independently of the manner in which the optimization input was derived. Once the parameters characterizing the optimization input I₀ are known, real or simulated collections of returns characterized by optimization input I₀ are resampled by a resampler 105 that picks sample returns from each of the distributions 101 in accordance with the likelihood governed by the parameter set {μ₀, Σ₀} of picking a particular return in each case. Many sorts of resamplers are known: one, for example, is a Roulette wheel, which picks numbers based on an ideally flat distribution of probabilities. Typically, resampler 105 is implemented in software that is embodied in a tangible and non-transitory medium such as a computer disk or a recordable medium.

The result of applying resampler 105 to pick sample returns from the distributions of optimization input I₀ is resampled input 107 which is then provided as input to a mean-value (MV) optimizer 110 that calculates a set of resampled optimal portfolios 112 as a function of level of risk, collectively, a resampled efficient frontier 114. This process is repeated, in recursion loop 115, for a number of times governed by the forecast confidence level, all as taught in the Michaud references cited above and incorporated by reference. The plurality of resampled optimal portfolios 112 are processed, typically in accordance with a statistical weighting on the basis of a norm in portfolio space (the space spanned by asset classes in which the set of portfolios comprised of weighted asset classes are vectors) in order to derive an resampled efficiency (RE) optimized portfolio P₀. All of the foregoing, as stated, is taught in detail in the Michaud references cited above and incorporated herein by reference.

Now, say that the foregoing process, depicted in FIG. 1, is repeated and another RE optimized portfolio 120, different from P₀, is determined to be optimal. Do the data warrant a rebalancing of portfolio weighting in order to shift holdings from P₀ to portfolio 120? That is the question addressed by the present invention. To the extent to which the identical optimization data input I₀ is used in two subsequent applications of the optimization procedure of FIG. 1, it is obvious that P₀ and portfolio 120 are statistically identical, since they derive from the identical input. Therefore, there is no sense in incurring transaction costs associated with buying and selling assets in order to rebalance a portfolio by shifting holdings from P₀ to portfolio 120.

But, what if the optimization input Iₖ={μₖ, Σₖ} that leads to RE-optimized portfolio Pₖ incorporates some of the same information used to derive I₀={μ₀, Σ₀} but also some additional information. Is a rebalancing to shift assets from P₀ to Pₖ now warranted?

Rebalancing Framework. Whether to rebalance an existing portfolio, in its current drifted status, and designated herein as P, is expressed in terms of a Michaud rebalance probability R(k), where k>0 indicates the “freshness” of the optimization input relative to the existing optimization data input I₀ from which the current optimized portfolio P₀ was derived.

To state the problem rigorously, Xₜ is the data available at time t and is statistically modeled with density f(X|θ), where θ represents the parameters of a model, such as a multivariate normal model, for example. The best available information for θ at time t comes from the posterior density f(θ|Xₜ), and the model for future observations X* is the posterior predictive distribution with density f(X*↑Xₜ). Predictive distribution f(X*|Xₜ) implies a probability distribution on [symbol] (P*, Pₜ), where P* is the resampled efficient frontier evaluated on a random draw from f(X*|Xₜ). The rebalance probability R(t) is the cumulative distribution function of that implied distribution evaluated at the observed discrepancy between the current drifted portfolio P and the optimal portfolio Pₜ. That is to say that R(t) is the probability that [symbol] (P*, Pₜ) for a random draw is less than [symbol] (P, Pₜ) for any specified portfolio.

Thus, for example, a portfolio manager might hold portfolio P₀ on the RE frontier at time 0, and at a given time k>0, the manager computes an appropriate associated RE optimized portfolio Pₖ. While k may concretely characterize a management style or investment product in terms of a “typical” frequency of rebalancing (such as an annual rebalancing cycle of a value manager as opposed to the monthly horizon of a growth manager), the parameter k, referred to, herein, as an “anticipated trading period,” may, more generally, serve as a heuristic for customizing manager investment style relative to the monitoring rule.

The critical range for the Michaud rebalancing rule at confidence level L is [L, 100], which is to say that the null hypothesis (that no rebalancing is called for) is rejected only for R(k) exceeding L. It is to be understood that, within the scope of the present invention, P₀ need not be an optimal portfolio but may reflect, instead, a current portfolio, however it may have evolved.

The decision to trade is often a function of accumulated new data. However, in many applications, the optimal portfolio Pₖ includes some of the same information used to construct P₀. Due to overlapping data, typical rebalance probabilities may be quite small, and, in many cases, may signal a need for rebalance in spite of being substantially less than the nominal threshold L. The next section provides general computational procedures for defining C_{L}(k), where C_{L}(k) is an overlap-adjusted threshold (or “critical value”) for given data sets and confidence level L. C_{L}(k) is a new cutoff value that takes overlapping data into account, effectively, a renormalization of the trading threshold L.

To cast the data overlap rigorously, Xₜ may be considered as the union of two sets, X_{t∩0} and X_{t\0}, the intersection and set difference of Xₜ with respect to X₀, respectively. Then, C_{L}(k) is defined as the L^{th} percentile of the distribution of R(t) induced by replacing X_{t\0} with a random draw from its predictive distribution within the calculation of Pₜ.

As k increases, C_{L}(k) has a limiting value of L, as k goes to T, when current and target portfolio ranks are equal and T is the same as the number of simulations in the rebalance test. T is associated with the Forecast Confidence™, which has been defined in the Michaud references. In the context of overlapping data in the optimization inputs, C_{L}(k) is the lower limit of a more suitable range for interpreting a rebalance statistic as a positive rebalance signal at confidence level L.

The “operating characteristic” (OC) of a given data set is defined to be the graph of C_{L}(k) as a function of k for given confidence level L for Pₖ relative to P₀, As k increases R(k) tends to increase and crosses the critical probability C_{L}(k) at some k. The OC provides a rigorous statistical benchmark for a given data set and parameters L and k for determining whether trading is desirable at a given time period.

### Computing the Operating Characteristic

A. The Case of MV Inputs Defined by Prior Historical Returns

A first class of embodiments of the invention treats MV inputs that are defined by prior historical returns for both P₀ and Pₖ. While less prevalently employed in actual applications, this class is of particular heuristic value in exemplifying salient features of the RE monitoring computation. A second case, discussed infra, in often preferred in many investment processes, though all of the described embodiments are within the scope of the present invention as claimed.

In the first class of embodiments of the invention, return series X₀=[x_{I}, . . . , x_{T}] is used to calculate optimization inputs I₀=(μ₀ ,Σ₀). That is to say, data are acquired over the course of T periods of time (by “observation”), and distributions 101 are parameterized in terms of the set {μ₀ ,Σ₀}. Similar, after k further periods of time, an new set of T periods of time are sampled (by “observation”), and the return series Xₖ=[x_{k|1}, . . . , x_{T|k}] is used to calculate a new set of optimization inputs, Iₖ=(μₖ,Σₖ). The number of overlapping periods is T-k, assuming, of course, that T>k, otherwise there are no overlapping periods.

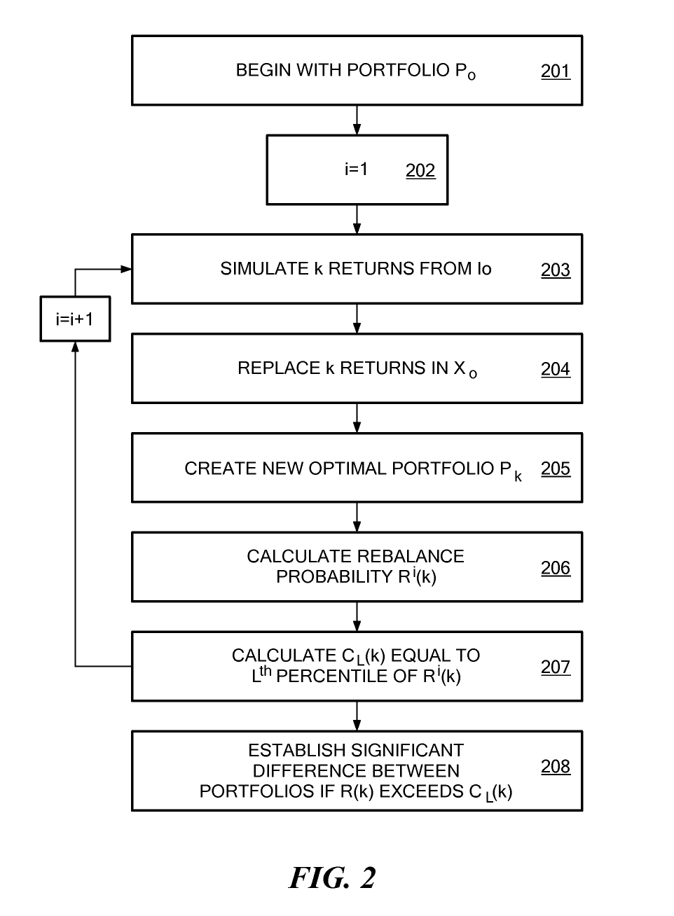

Now, the RE optimization process occurs over T resampling periods. The following algorithm uses a partial resampling framework for computing the operating characteristic (OC) of the Michaud need-to-trade probability in the presence of overlapping data. The OC is computed for a given data set in terms of the parameters k, T, L, and Z, where Z is the number of simulations for computing C_{L}(k) for each k, as now described with reference to FIG. 2.

Portfolio P₀ 201 may have been computed on the basis of I₀, as taught in the Michaud references and depicted, schematically, in FIG. 1. Setting i=1 as the index of an outer loop (202), k new returns (designated r₁, . . . , rₖ) as are simulated (203) from I₀, and are then used to replace (204) k randomly selected returns in X₀. The resulting set of returns is used to compute (205) a new optimal portfolio Pₖⁱ and its rebalance probability Rⁱ(k) is calculated (206) from the returns used to generate Pₖⁱ, each of which may be referred to herein as an “simulated optimal portfolio.” This process is repeated until Z optimal portfolios and rebalance probabilities have been generated.

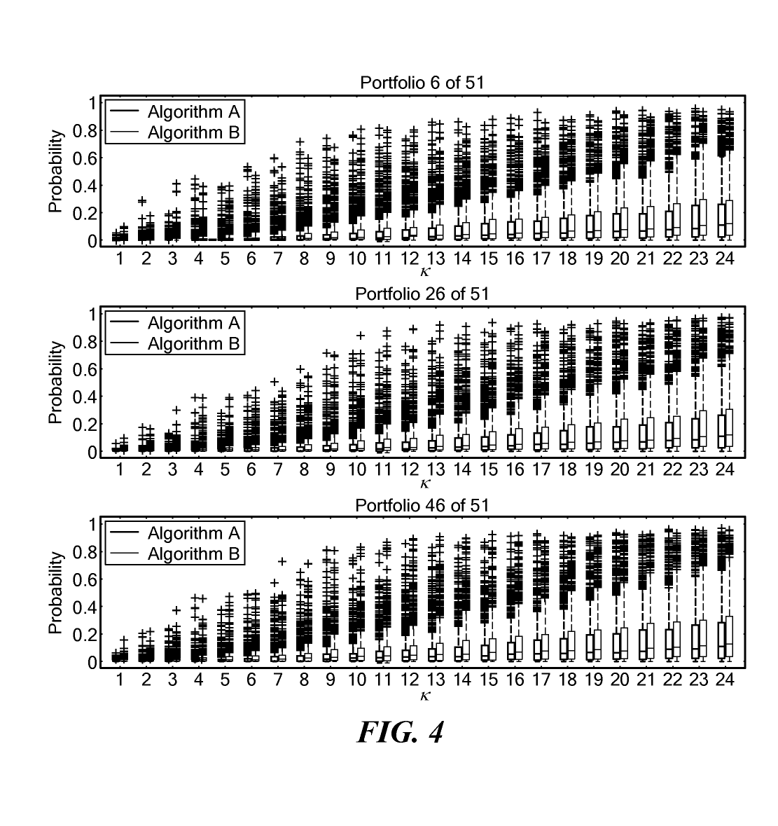

The set of Z new rebalance probabilities may then be used to compute (207) a critical value C_{L}(k) equal to the L^{th} percentile value of Rⁱ(k). Plots of C_{L}(k) as a function of k are shown in FIG. 4 for varying values of L, with the graph of C_{L}(k) as a function of k constituting the operating characteristic.

If the rebalance probability R(k) (which is the rebalance probability derived using returns Xₖ from optimization inputs Iₖ to calculate an optimal portfolio Pₖ from distribution Iₖ) exceeds C_{L}(k), then the portfolio according to P₀ needs to be revised.

B. General MV Optimization Input Estimation

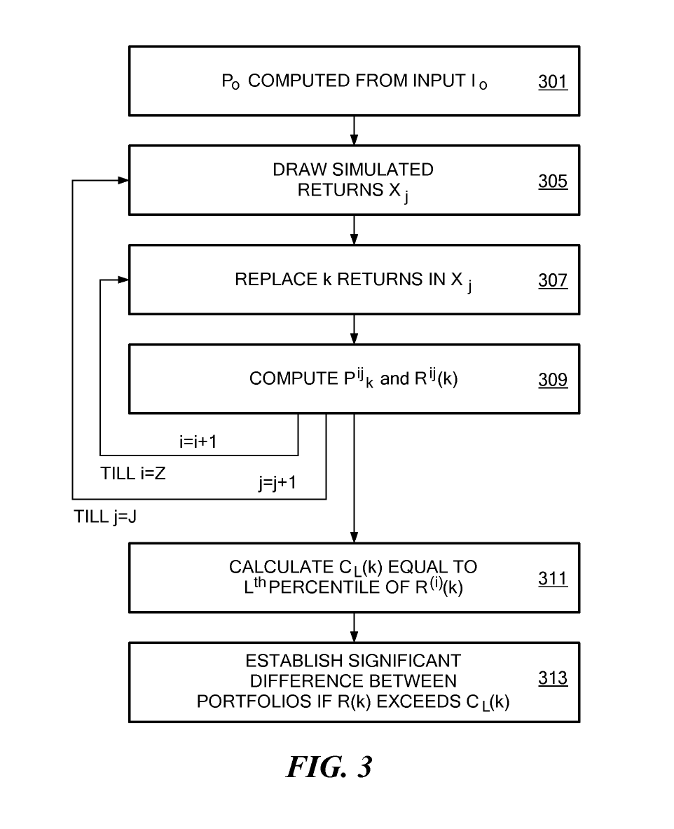

Few, if any, asset managers rely solely on historical returns for computing MV estimates for actual investment. Risk-return estimates generally reflect information from a very wide variety of sources and aspects of the investment process. RE optimized portfolios P₀ and Pₖ are based directly on optimization inputs I₀=(μ₀,Σ₀) and Iₖ=(μₖ,Σₖ) which may be assumed to be “given” on the basis of all sources that have been employed. In this context, there is no explicit value of T to define the number of draws, but, rather, the number of simulations in each RE optimization must be assumed, and reflect whatever techniques have been used to modify MV inputs and enhance their forecast value, as discussed in Chaps. 8 and 11 of Michaud (2008a), and in references cited therein. The parameter T, associated with Forecast Certainty™, described in Chap. 6 of Michaud (2008a), represents the level of certainty in the MV estimates in terms of the number of independent, identically distributed (iid) returns from I₀ and Iₖ. The OC is computed similarly as in Case A by simulating several datasets to represent X₀ and aggregating the results. The results from the simulations are then pooled to approximate the mixture distribution corresponding to the inputs. In accordance with a further embodiment of the present invention, another method for determining whether to trigger rebalancing of a portfolio P₀ to the weights specified in portfolio Pₖ is now described with reference to FIG. 3.

The method begins with an RE-optimal portfolio P₀ computed from input I₀. and Iₖ. For all j between 1 and T, a set of returns is simulated (305): Xⱼ={x₁^{j}, . . . , x_{T}^{j}}. Then, iterating on index i, k randomly selected subsets of returns in each of the X, sets are replaced (307) with simulations from I₀, yielding new sets of returns with replacements: Xᵢⱼ={x₁^{ij}, . . . , x_{T}^{ij}}. Each of the replacements allows an optimal portfolio Pₖ^{ij} and a rebalance probability R^{ij}(k) to be computed (309), and the process is repeated until i=Z and j=J, where J is a parameter that affects the resolution of the process. R⁽ⁱ⁾(k) represents the pooled R^{ij}(k) for j=1, . . . , J, on the basis of which a critical value C_{L}(k) is calculated (311) as the L^{th} percentile of R⁽ⁱ⁾(k). Once the foregoing process has been repeated for all desired values of k (with, as before, the OC reflected as a graph of C_{L}(k) as function of k), a determination that R(k) exceeds C_{L}(k) is an indication of a need to trade.

Example of an Application of a Method is Accordance with an Embodiment of the Invention

An illustration of OC RE monitoring in accordance with an embodiment of the present invention is now described with reference to FIG. 4 with respect to two data sets used in prior RE optimization studies. The first data set represents an asset allocation case for eight capital market indices as described in Michaud (1998, Ch. 2). The data consists of 18 years of monthly historical total returns for eight capital market indices, six equities and 2 fixed income, from January 1978 to December 1995. The RE optimized portfolios P₀ and Pₖ are constrained to have 60% equity and 40% bonds. The case of T=120 monthly periods is illustrated, for purposes of example. P₀ is the RE optimized portfolio estimated at December 1990. Pₖ is the RE optimized portfolio estimated at k monthly periods subsequent to December 1990. If k=12, for example, then Pₖ is the RE optimized portfolio at December 1991. The OC is computed for values of k from 1 to 24 and shown for confidence levels L=[0.50, 0.75, 0.90, 0.95].

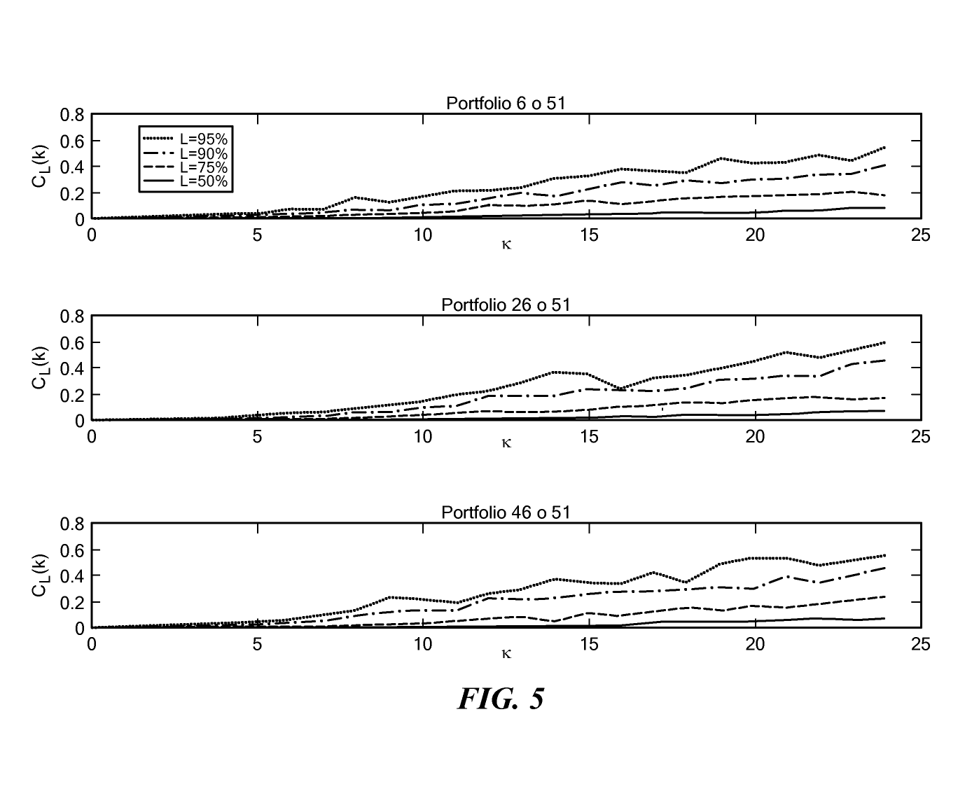

FIG. 5 displays the critical optimality probability as a function of k for three targeted portfolios on the REF based on ten years of monthly historical returns for the indicated confidence levels. For example, the need-to-trade probability required in one year (k=12) at the 90% confidence level is roughly 20%. Theoretically the OC curves are monotone increasing as a function of monitoring time; Monte Carlo estimation error is responsible for deviations. The figure vividly demonstrates the impact of overlapping data on the Michaud rebalancing rule. Even after a year the critical probability required for trading to optimal is far less than confidence level L. The results also may be conditional on the risk level of the target REF optimal portfolio. A lower (higher) REF risk target may reduce (increase) the level of probability required for trading. Note that neither low nor high critical probabilities are associated with trading frequency, all other things equal. The critical probability is simply the benchmark for measuring optimality relative to estimation error and assumptions.

In a particular investment strategy, an optimal portfolio might be chosen by some other method than target rank; for example, to match a particular stock/bond ratio. In this case the optimal portfolio at time k will very likely have a different rank than at time 0. This case is easily handled by the portfolio monitoring technique presented here. The rebalance probabilities corresponding to the rank at time k are collected and portfolios are compared at the new rank. It is clear that the distribution of rebalance probabilities is shifted towards greater values when the target rank differs from the rank of the held portfolio. The limiting distribution of rebalance probabilities as k goes toward T is in fact more concentrated toward 1 than a uniform distribution, since portfolios from other frontier ranks would be expected to have greater tracking error on average than portfolios from the same portfolio rank. So C_{L}(k) tends toward a value greater than L as k goes toward T.

Within the scope of the present invention, the portfolio monitoring procedure described herein may be further generalized. The OC depends only on optimality of Pₖ, not P₀. It is necessary that optimality is defined in the context of investment practice. While trading costs are ignored the algorithms can be generalized to include them.

Apart from the natural constituents of any investment process, such as size and character of the asset universe and desired risk levels, the parameters T and L should be customized to the manager, advisor, or institutional demand characteristics. Some guidelines may be of interest. A value manager may have less volatile portfolios relative to growth, momentum, or statistical arbitrage investment styles. Consequently value managers may want to trade less often by requiring higher values of L or T. However, even within a style there can be wide variations. However, many factors can be approximated with reasonable appropriateness.

One reason that simulations in accordance with the present invention are computationally intensive is because the OC is computed for many values of k. In practice a manager is likely to be interested in only one value of k. In applications the set of monitored portfolios may differ by risk level. The monitoring process by associating each portfolio with one of several pre-defined target REF portfolios. Once the critical probabilities are computed, assessing need-to-trade optimality requires only a table lookup. Consequently automated portfolio monitoring may be practical even for large numbers of portfolios.

### Generalized and Heuristic Significance of the Parameters

Implementation of the Michaud monitoring rule requires appropriate definitions of the OC parameters. Proper setting of the parameters allows customization of the procedure relative to a manager's information set, investment process, client objectives and other considerations.

The parameter L in the OC plays a key role in the procedure. It is the global enforcer of the Michaud rule. L is the upper limit for C_{L}(k) as k increases. It reflects the rebalance test cutoff value when there is no information overlap. L may be useful in the case of a contributed non-optimized portfolio. A large L reduces trading frequency by avoiding the danger of trading in noise but may also ignore performance opportunities. Alternatively, a small L increases trading frequency by more closely tracking to target but may result in statistically ineffective trades. Setting L to 50% places the trading threshold right in the center of the simulated rebalance probabilities. An alternative statistic that may be employed in an odds ratio of rebalancing more than intended vs. less than intended. This would be expressed as (1-L)/L. At L=50%, this would be 1, implying you're just as likely to be rebalancing more often than every k time periods as less. At L=33%, for example, the statistic would be 2, meaning you're twice as likely to be trading more often rather than less often than intended. Which error is more important is up to the manager. Clearly L is a function of the manager's investment style, information level, outlook, as well as other considerations.

The value of L also depends on a manager's presumption of the level of information in risk-return estimates at given time t. This is controlled in part by the Forecast Confidence™ (FC) parameter (which may assume a value between 1 and 10) of the RE optimization process. In all forms of Michaud RE analysis, the FC corresponds to the number of simulated returns used to create each simulated RE frontier; the more returns the less uncertainty in point estimates. In the simplest analysis based on data alone, the FC is the number of time periods of data, also indicated by the parameter T, although it need not be since they are used in different parts of the analysis.

FC interacts with L. A high FC value may be associated with a lower level of L and vice versa. This is because the manager may decide that the information is very reliable and tracking to optimality is more important than the likelihood of trading without effectiveness. In practice, FC levels should reflect the investor's confidence in the input estimates, independently from the other parameters in the monitoring process. Lower FC levels create more dispersion in the resampled datasets, and generally more diversified RE portfolios. FC level may also be associated with manager style, investment horizon, product characteristics, and trading target.

The parameter k can be assigned to reflect a “normal” or “conventional” calendar based rebalancing schedule. The value of k may depend on manager style, client objectives, marketing imperatives and other considerations. For example, a value manager would presumably use a greater value of k than an aggressive hedge fund manager. The monitoring rule may indicate need-to-trade for time t prior or post calendar based k. Alternatively, if no trading schedule exists, then k is equal to t.

Because risk-return estimates are likely to be managed, practical application of the monitoring technique suggests a preference for the embodiment of the invention described above with reference to FIG. 3. In this case the manager is free to choose the parameter T as appropriate that need not correspond to actual length of time, but rather reflect aspects of the turnover of information in the inputs. The parameter T reflects the time it takes for information to completely cycle out of the analysis. This is straightforward when the only source of information is historical data as in algorithm A. However, when investor views are included the length of the information cycle is more ambiguous and needs to be estimated. As T becomes smaller, the rebalancing threshold C_{L}(k) will more rapidly increase as k increases.

The parameters Z and J affect precision of the Monte Carlo estimates and can be set according to the problem.

Once the parameters have been defined and the OC computed, the implementation of the monitoring rule is straightforward. The manager calculates the Michaud rebalance test R(t) for portfolio P₀ relative to the new optimal Pₜ and compares the value to C_{L}(k). Rebalance probabilities greater than C_{L}(k) indicate that rebalancing may be desirable. Based on an indication that rebalancing may be desirable, trading may be instituted to transform portfolio P₀ and to bring it into alignment with a newly optimized target portfolio.

While embodiments of the invention have been described with reference to an RE optimized P₀, there is no need of the optimization assumption for using the procedure. In many practical cases P₀ is a drifted, partially rebalanced, or even non-optimized portfolio though one presumably associated with I₀ inputs.

While embodiments of the present invention have been described with reference to a single portfolio, it is to be understood that the teachings provided herein may be advantageously applied to multiple “portfolios” (or, more generally, vectors of coefficients) or to classes of portfolios. Thus, once a need to trade has been triggered with respect to a particular class of portfolios, that need-to-trade may be applied across multiple portfolios.

It should also be understood that equivalent formulations of a need-to-trade, such as in terms of an effective age of a portfolio (with the “effective age” as defined below), are within the scope of the present invention as claimed. More particularly, as described herein, the calibrated rebalance test is positive when R(t)<C_{L}(k). However, it is to be understood that the same test may also be performed, equivalently, on two alternate scales, with the same outcome, but different interpretations.
Viewed as a function of k, C_{L}(k) is zero when k=0, and increases monotonically as k increases. Thus under normal circumstances, for a given R(t), there is a minimum k, denoted herein as k*, such that the test is positive for k>k*, i. e., for all k>k*, R(t)<C_{L}(k). This is an equivalent statement of the adjusted rebalance test to rebalance if a portfolio's k* is greater than the manager's anticipated trade period. The parameter k* may be referred to as an “effective age” of a portfolio, with reference to the calibration at the time of previous rebalance.
The calibrated rebalance test can also be transformed back to the original uniform scale from 0 to 1. The set of simulated rebalance probabilities forms an empirical distribution in the unit interval. Since the statement R(t)<C_{L}(k) is equivalent to Pr(Rⁱ(k)<R(t))<L, one can perform the rebalance test on the original scale, rejecting the null hypothesis of no need to trade if Pr(Rⁱ(k)<R(t))<L. Pr(Rⁱ(k)<R(t)) can be calculated by dividing the count of simulations Rⁱ(k) that are less than R(t) by the total number of simulations Z. Pr(Rⁱ(k)<R(t)) may be referred to as the “adjusted rebalance statistic,” since it is simply compared to the desired level of significance L.

The procedures presented herein by way of example have a number of generalizations. In particular there is no need for the target portfolios to reside on the REF or any efficient frontier. Since the ability to resample datasets enables computation of statistical equivalence regions, any portfolio calculation method, along with a measure of portfolio similarity, can produce a rebalance test statistic which could be calibrated by the procedure in this paper. Note also that I0 and It can parameterize any return distribution not just mean-variance based.

The parameters required to define the monitoring rule provide interesting opportunities to dynamically manage an investment process. In accordance with alternate embodiments of the present invention, changes in the market outlook, manager's information level, client investment objectives, marketing imperatives or other considerations can be built into the definition of C_{L}(k) to tune the monitoring rule in real time for more effective management.

Portfolio optimization is based on a model which assumes a stationary distribution of returns. The Michaud rebalancing statistic will detect an optimal portfolio whose tracking error exceeds that of typical equivalent RE portfolios. Factors which cause this are the very same ones which affect estimation of the mean. If the mean estimate is perturbed by the shift in data observations significantly, the uncalibrated Michaud rebalance statistic will detect this. However, in the presence of overlapping data, methods in accordance with the present invention will also detect significant deviations in portfolio tracking error, simply adjusting the cutoff value so that more power can be obtained in the test. This is necessary to achieve reasonable sensitivity to recommend trading when necessary. The Michaud statistic with the nominal cutoff number would rarely recommend trading and would not be useful in a practical monitoring application.

Various embodiments according to the invention may be implemented on one or more computer systems. These computer systems may be, for example, general-purpose computers. It should be appreciated that systems described herein for monitoring the need to trade in a portfolio may be located on a single computer or may be distributed among a plurality of computers attached by a communications network.

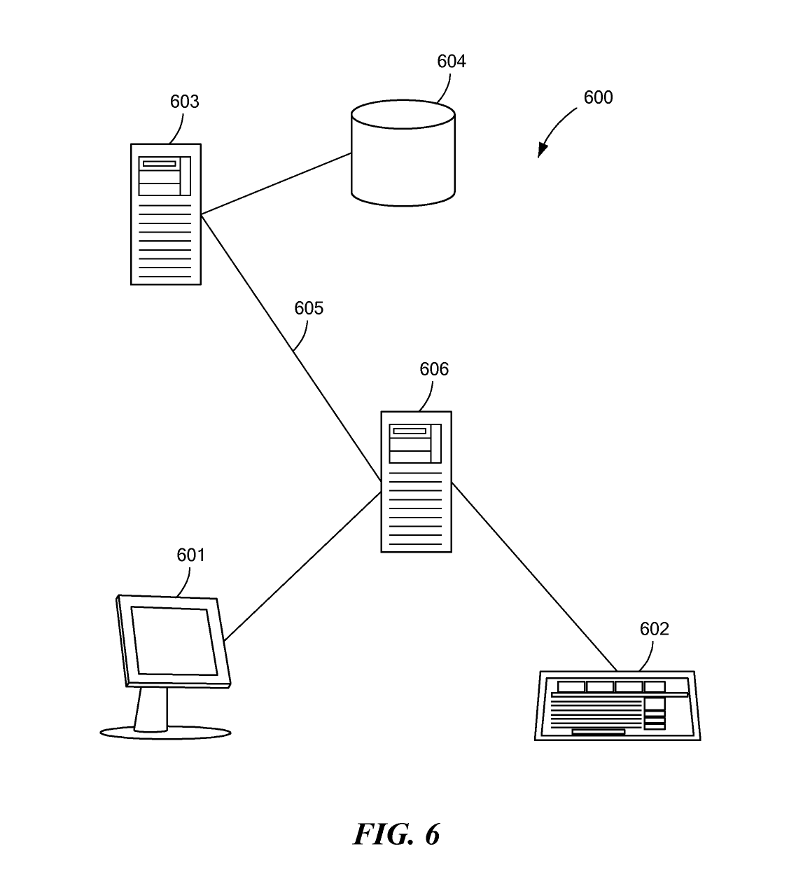

Various aspects of the invention may be implemented as specialized software executing in a general-purpose computer system 600 such as that shown in FIG. 6. The computer system 600 may include a database server 603 connected to one or more memory devices 604, such as a disk drive, memory, or other device for storing data. Database server 603 stores an investor portfolio comprising a plurality of assets, or other data to which the present invention may be applied. A processing server 605 contains computer-executable software configured to derive a threshold as taught in the foregoing description. Memory 604 is typically used for storing programs and data during operation of the computer system 600. Components of computer system 600 may be coupled by an interconnection mechanism 605, which may include one or more busses (e.g., between components that are integrated within a same machine) and/or a network (e.g., between components that reside on separate discrete machines). The interconnection mechanism 605 enables communications (e.g., data, instructions) to be exchanged between system components of system 600. Computer system 600 also includes one or more input devices 602, for example, a keyboard, mouse, trackball, microphone, touch screen, and one or more output devices 601, for example, a printing device, display screen, speaker. In addition, computer system 600 may contain one or more interfaces (not shown) that connect computer system 600 to a communication network (in addition or as an alternative to the interconnection mechanism).

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 600 is shown by way of example as one type of computer system upon which various aspects of the invention may be practiced, it should be appreciated that aspects of the invention are not limited to being implemented on the computer system as shown in FIG. 6. Various aspects of the invention may be practiced on one or more computers having a different architecture or components than that shown in FIG. 6.

Computer system 600 may be a general-purpose computer system that is programmable using a high-level computer programming language. Computer system 600 may be also implemented using specially programmed, special purpose hardware. In computer system 600, servers 603 and 605 are typically implemented on one or more commercially available servers.

Processors and operating systems (not shown) employed in conjunction with servers 603 and 605 define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate, or interpreted code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, while descriptions have been provided in terms of the demand characteristics of modern asset management in practice, they are not limited to this context. The procedures are applicable to a wide variety of process monitoring applications where inequality or other constraints require computational methods for estimation and inputs include overlapping data. In particular the procedures can be used for monitoring applications requiring multivariate linear regression with overlapping data and linear inequality constraints.

Moreover, where examples presented herein involve specific combinations of method acts or system elements, it should be understood that those acts and those elements may be combined in other ways to accomplish the same objective of dynamic portfolio monitoring. Acts, elements and features discussed only in connection with one embodiment are not intended to be excluded from a similar role in other embodiments. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Additionally, single device features may fulfill the requirements of separately recited elements of a claim.

What is claimed is:

1. An apparatus for calibrating a need-to-trade trigger threshold based on two separate sets of optimization inputs corresponding to a stochastic process, the apparatus thereby accounting for common information in the two separate multivariate stochastic inputs, the apparatus comprising:
a. a database server storing an initial portfolio comprising a plurality of assets, each asset characterized by a weighting coefficient, the plurality of assets defining a vector in a portfolio space;
b. a processing server having stored thereon computer-executable software configured to derive need-to-trade probability based on a first set of data based, in turn, on a first optimization input and a second set of data based on a second optimization input, the first and the second sets of data derived by at least one of observation, resampling and meta-resampling;
c. a computer-executable module resident on the processing server for recursively replacing a subset of the first set of data with data sampled from the second optimization input to a specified extent of replacement, thereby generating a substituted set of data, the extent of replacement governed by an extent of common information, and for calculating an ensemble of ersatz optimal portfolios having an ersatz optimal portfolio for each of the substituted sets of data;
d. a computer-executable module for calculating a set of rebalance probabilities on the basis of the ensemble of ersatz optimal portfolios;
e. a computer module for selecting the L^{th} percentile for the set of rebalance probabilities, where L is a specified confidence level, to derive an adjusted critical value; and
f. a computer-executable module for establishing the need-to-trade trigger when an observed rebalance probability exceeds the adjusted critical value corresponding to the specified confidence level L.

2. An apparatus in accordance with claim 1, where the first and second sets of data are derived by observation.

3. An apparatus in accordance with claim 1, further comprising a computer-executable module for receiving a user-specified anticipated trading period and for deriving therefrom the extent of common information.

4. A computer-implemented method for establishing a need-to-trade trigger triggering a rebalancing trade on the basis of a two separate sets of optimization inputs corresponding to a stochastic process, the method thereby accounting for common information in the two separate optimization inputs, the method comprising:
a. drawing a first set of data based on a first optimization input and a second set of data based on a second optimization input, the first and the second sets of data derived by at least one of observation, resampling and meta-resampling;
b. recursively replacing a subset of the first set of data with data sampled from the second optimization input to a specified extent of replacement, thereby generating an ensemble of simulated portfolios, the extent of replacement governed by an extent of common information;
c. calculating a set of rebalance probabilities on the basis of the ensemble of simulated portfolios;
d. selecting the L^{th} percentile from the set of rebalance probabilities, where L is a specified confidence level, to derive an adjusted critical value; and
e. triggering a need-to-trade when an observed rebalance probability exceeds the adjusted critical value corresponding to the specified confidence level L.

5. A computer-implemented method in accordance with claim 4, wherein the first and second sets of optimization inputs are based on historical data.

6. A computer-implemented method in accordance with claim 4, further comprising:
receiving a user-specified anticipated trading period and deriving therefrom the extent of common information.

7. A computer-implemented method in accordance with claim 4, wherein the need-to-trade trigger threshold is applied to a plurality of portfolios.

8. A computer-implemented method in accordance with claim 4, further comprising transforming a current portfolio into alignment with a target portfolio when the observed rebalance probability exceeds the adjusted critical value.
